(19) United States
(12) Patent Application Publication
(10) Pub. No.: US 2026/0148020 A1
(43) Pub. Date: May 28, 2026

(54) DOCKING STATION FOR A TRANSLATION DEVICE, CONTROL METHOD AND TRANSLATION SYSTEM

(71) Applicant: Goertek Technology Co., Ltd., Qingdao (CN)

(72) Inventors: Ruicong Xiao, Shandong (CN); Xiaofei Zhou, Shandong (CN); Lichao Chen, Shandong (CN); Liang Zhang, Shandong (CN); Shuangshuai Zhu, Shandong (CN); Peng Guan, Shandong (CN); Jiahao Liu, Shandong (CN); Changhong Zhao, Shandong (CN)

(73) Assignee: Goertek Technology Co., Ltd., Qingdao (CN)

(21) Appl. No.: 19/248,793

(22) Filed: Jun. 25, 2025

(30) Foreign Application Priority Data
Nov. 28, 2024 (CN) 202411729923.0

(51) Int. Cl. G06F 40/58; G06F 1/16

(52) U.S. Cl. CPC G06F 40/58; G06F 1/1632

(57) ABSTRACT

The disclosed subject matter provides a docking station for a translation device, a control method, and a translation system. The docking station includes a communication module in wireless communication connection with at least a first translation device and a second translation device, the communication module configured for receiving first information to be translated sent from the first translation device and sending translated second information to at least the second translation device based on the wireless communication connection, a language type of the second information corresponding to the second translation device and the second information comprising at least one language type different from that of the first information; and a control module configured for receiving the first information transmitted by the communication module, translating the first information into the second information, and sending the second information to at least the second translation device via the communication module.

### CROSS-REFERENCE TO RELATED APPLICATIONS

The present disclosure claims priority to Chinese Patent Application No. 202411729923.0, filed on Nov. 28, 2024, which is hereby incorporated by reference in its entirety.

### TECHNICAL FIELD

The present disclosure relates to the field of translation devices, and particularly to a docking station for a translation device, a control method and a translation system.

### BACKGROUND

Currently, multilingual meetings mainly rely on a combination of human and machine translation for mutual translation. In terms of human translation, conferences often employ multiple interpreters who are proficient in different languages to complete the translation tasks through consecutive simultaneous interpretation. At the same time, this method of consecutive simultaneous interpretation will generate a certain time delay, which is unavoidable under current technical conditions.

In addition, although machine translation technology has made significant progress in recent years, especially driven by technologies such as neural network machine translation, existing translation machines still cannot conveniently handle all situations in multilingual meetings. For example, in the aforementioned multilingual scenario, to achieve accurate recognition and translation, the translation machine needs to determine in advance the language type to be input before each person from a different country speaks, which is inconvenient in operation. Furthermore, due to the limited range of sound collection by the translation machine, it may also encounter problems of inaccurate sound collection in the above-mentioned scenarios.

### SUMMARY

An objective of the present disclosure is to provide a docking station for a translation device, a control method and a translation system, which can solve the problem that an ordinary translation device cannot be applied to multilingual conference scenarios.

According to a first aspect of the present disclosure, a docking station for a translation device is provided, which includes:
a communication module in wireless communication connection with a plurality of translation devices, the communication module being configured for, based on the wireless communication connection, receiving first information to be translated sent from any translation device and sending translated second information to other translation devices, a language type of the second information corresponding to the other translation devices and comprising at least one language type different from that of the first information; and
a control module configured for receiving the first information transmitted by the communication module, translating the first information into the second information, and sending the second information to the other translation devices via the communication module.

Optionally, the docking station further includes a charging module, which includes a plurality of charging ports configured for charging the plurality of translation devices.

Optionally, the docking station further includes a display module configured for displaying status information of the plurality of translation devices, and the status information at least includes a language type corresponding to each translation device.

Optionally, the docking station is provided with an interaction control, which is a physical control and/or a virtual control displayed on the display module for each translation device, and is at least configured for setting a language type corresponding to each translation device.

Optionally, the plurality of translation devices are provided with interaction controls, which are virtual controls and/or physical controls, and are configured for setting language types corresponding to the plurality of translation devices, and sending the language types corresponding to the plurality of translation devices to the docking station based on the wireless connection.

Optionally, “translating the first information into the second information, and sending the second information to the other translation devices via the communication module” includes:
determining a language type corresponding to each of the other translation devices respectively;
translating the first information based on the language type corresponding to each of the other translation devices, and sending translated information to corresponding other translation devices based on language types via the communication module.

Optionally, the control module is further configured for: adding identity information of a translation device sending the first information to the second information to enable users of the other translation devices to determine a source of the second information.

According to a second aspect of the present disclosure, a control method for a docking station for a translation device is provided, which is applied to the docking station for the translation device according to any one of the first aspect, and the method includes: receiving first information to be translated sent from any translation device; translating the first information into second information and sending the second information to the other translation devices, wherein a language type of the second information corresponds to the other translation devices and includes at least one language type different from that of the first information.

Optionally, “translating the first information into second information and sending the second information to the other translation devices” includes:
determining a language type corresponding to each of the other translation devices respectively;
translating the first information based on the language type corresponding to each of the other translation devices, and sending translated information to corresponding other translation devices based on language types.

According to a third aspect of the present disclosure, a translation system is provided, which includes the docking station for the translation device according to any one of the first aspect and a plurality of translation devices.

One technical effect of the present disclosure is to provide a docking station for a translation device, which can establish wireless communication connections with a plurality of the other translation devices, so as to receive information sent by any of the translation devices, then translate the received information into information in at least one different language corresponding to the other translation devices, and subsequently send the translated information to the other translation devices. In this way, the problem of inconvenient operation encountered when using the translation devices is addressed. At the same time, each user can hold one translation device to speak or input content to be expressed, thereby also solving the problem of inaccurate sound collection in conference scenarios.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which constitute a part of the description, illustrate embodiments of the present disclosure and, together with the description thereof, serve to explain the principles of the embodiments of the present disclosure.

FIG. 1 is a structural schematic diagram of a docking station for a translation device according to one embodiment;

FIG. 2 is a schematic diagram of a display module of a docking station for a translation device according to one embodiment;

FIG. 3 is a schematic diagram of a display module of a docking station for a translation device according to one embodiment;

FIG. 4 is a schematic diagram of a translation device according to one embodiment;

FIG. 5 is a flowchart of a control method for a docking station for a translation device according to one embodiment.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

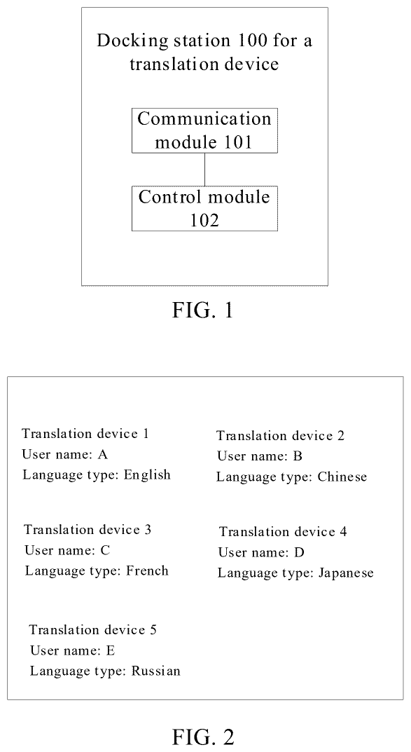

Embodiments of the present disclosure provide a docking station 100 for a translation device, which, as shown in FIG. 1, includes: a communication module 101 in wireless communication connection with a plurality of translation devices, the communication module 101 being configured for, based on the wireless communication connection, receiving first information to be translated sent from any translation device and sending translated second information to other translation devices, a language type of the second information corresponding to the other translation devices and comprising at least one language type different from that of the first information; and a control module 102 configured for receiving the first information transmitted by the communication module 101, translating the first information into the second information, and sending the second information to the other translation devices via the communication module 101.

In the present embodiment, the translation device may be a standalone translation machine that can be used independently and realizes translation functions, and may include a wireless communication module, such as a Bluetooth module or a WiFi module, which is in wireless communication connection with the docking station. In another example, the translation device that is in wireless communication connection with the docking station of the present disclosure may not possess independent translation capabilities itself, but instead rely on the docking station to perform translation functions. The translation device itself may only include a wireless communication module, a display module, or an acquisition module, wherein the display module can display translated information sent by the docking station for the user to obtain, and the acquisition module can acquire voice or text input by the user.

In the present embodiment, the communication module of the docking station may also be a communication module such as a Bluetooth module or a WiFi module. The docking station may be in communication with the plurality of translation devices based on the wireless communication module, and based on the wireless communication connection, may receive information to be translated sent by one translation device, wherein the information may be voice information or text information. At the same time, the docking station may also send translated information to other communication devices based on the wireless communication module, wherein the information may also be voice information or text information.

In the present embodiment, the docking station is further provided with a control module, which may include a processor, a memory, and so on, and can pre-store a large number of corpora and various translation models therein for translating the information sent by the translation devices. In another example, the control module may also upload the information sent by the translation devices to the cloud, and perform translation using language corpora and models stored in the cloud.

In the present embodiment, each translation device that is in communication connection with the docking station may correspond to one language type. The language type corresponding to each translation device may be set by the user through the translation device, and then the language type corresponding to the translation device is notified to the docking station via the wireless communication connection. Alternatively, the language type corresponding to each translation device may be directly set by the docking station. In this example, the language type corresponding to the translation device is the language type used by the user associated with that translation device.

In one example of the present embodiment, the docking station further includes a charging module, which includes a plurality of charging ports configured for charging the translation devices.

In the present embodiment, the docking station can also be provided with a plurality of charging ports. In one example, the charging port may be a wired charging port, and after being connected to the translation device, it can charge the translation devices. In another example, the charging port may also be a wireless charging port, which, when the translation device is placed on the port, can perform wireless charging on the translation device based on the principle of electromagnetic induction, using the magnetic induction coil inside the docking station and the magnetic induction coil inside the translation device.

In one example of the present embodiment, the docking station may be provided with slots or recesses that can accommodate and hold a plurality of translation devices. In one example, the charging ports may be arranged inside the slots or recesses, so as to automatically charge the translation devices placed thereabove.

In one example of the present embodiment, the docking station further includes a display module, which is configured for displaying status information of the plurality of translation devices, and the status information at least includes the language type corresponding to each translation device.

In this example, the docking station may also have a display module, such as a display screen. The display screen may be a touch-sensitive display screen, or a non-touch screen that only displays content, and can display status information of the translation devices. As shown in FIG. 2, the docking station is connected to five translation devices, namely Translation Device 1 to Translation Device 5, and the display module shows the status information of these five translation devices. In this example, the status information may include the language type and user name corresponding to each translation device. In other examples, the status information may further include the remaining battery level of each translation device.

In one example of the present embodiment, the docking station is provided with an interaction control, which is a physical control and/or a virtual control displayed on the display module for each translation device, and is at least configured for setting a language type corresponding to each translation device.

In the present embodiment, the interaction controls provided on the docking station may be physical controls or virtual controls displayed on the display module. In this example, the physical controls may be knobs, buttons and so on, and may be provided on the surface of the docking station, specifically adjacent to the display module. In another example, the virtual controls may be dynamically presented on the built-in display module of the docking station (such as a high-definition touch screen). These virtual controls are presented through a graphical interface, each translation device connected to the docking station generates one corresponding virtual control icon on the screen, and users can perform various settings by touching these icons.

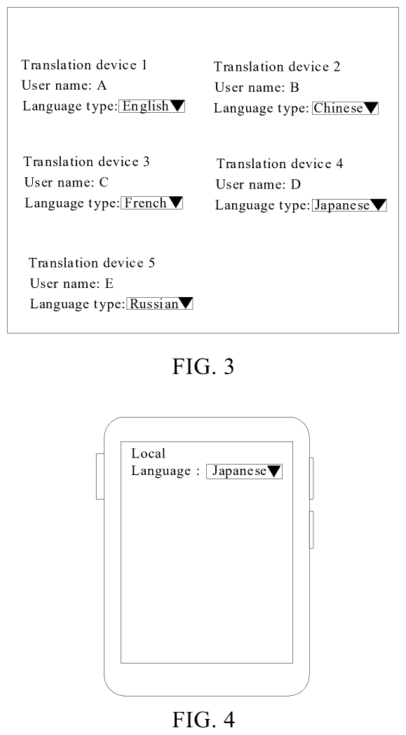

For example, when a user needs to set the language type corresponding to one translation device as Chinese, the user can rotate the language selection knob on the physical control until the information of the corresponding device on the display screen shows the label “Chinese”; alternatively, in the virtual control interface, as shown in FIG. 3, the user only needs to tap the language type control (the black triangle) of the target translation device to open a drop-down menu and enter a detailed selection card, then slides a selection bar or directly clicks options in the drop-down menu to quickly complete the setting of the language type.

In addition, the design of the interaction controls on the docking station fully considers user-friendliness and supports a plurality of operation modes, such as single-tap, double-tap, long-press, and swipe, so as to meet usage requirements in different scenarios. At the same time, the virtual control interface on the display module is clear and intuitive, provides rich visual feedback, and ensures that users can accurately complete all settings without error.

In one example of the present embodiment, the plurality of translation devices are provided with interaction controls, which are virtual controls and/or physical controls, and are configured for setting language types corresponding to the plurality of translation devices, and sending the language types corresponding to the plurality of translation devices to the docking station based on the wireless communication connection.

In one example, the interaction control may also be provided on the translation device, and like the control on the docking station, it may also be a physical control or a virtual control. In this example, the physical control may be a knob, a button, or a side key, and so on, and may be provided on the surface of the translation device. In another example, the virtual control may be dynamically presented on the display screen of the translation device. These virtual controls are presented through a graphical interface, and users can perform various settings by touching these icons.

For example, when a user needs to set the language type corresponding to the local device to Japanese, they can use the side key on the local device to switch the language corresponding to the local device until the local language on the display screen appears to be the label “Japanese”; alternatively, in the virtual control interface, as shown in FIG. 4, the user only needs to tap the control (the black triangle) to open a drop-down menu and enter a detailed selection card, and then slides a selection bar or directly clicks options in the drop-down menu to quickly complete the setting of the language type.

In the present embodiment, “translating the first information into the second information, and sending the second information to the other translation devices via the communication module” comprises: determining a language type corresponding to each of the other translation devices respectively; translating the first information based on the language type corresponding to each of the other translation devices, and sending translated information to corresponding other translation devices based on language types via the communication module.

In this example, after the control module receives information sent by a certain translation device, it is possible to first determine which language types correspond to the other translation devices. For example, referring to FIG. 2, after the control module receives information sent by Translation Device 1, it is possible to first determine the language types corresponding to the other translation devices, namely Translation Devices 2, 3, 4, and 5, including “Chinese, French, Japanese, Russian”; then, the translation is performed based on these corresponding language types to translate the English information sent by Translation Device 1 into information in Chinese, French, Japanese, and Russian; afterwards, based on the language types of the translated information, the translated information is sent to corresponding translation devices, i.e., sending the Chinese information to Translation Device 2, the French information to Translation Device 3, the Japanese information to Translation Device 4, and the Russian information to Translation Device 5.

In one example of the present embodiment, the control module is further configured for: adding identity information of a translation device sending the first information to the second information to enable users of the other translation devices to determine a source of the second information.

In one example of the present embodiment, after the translation is completed, the control module may also add the identity information of the source device of the information or the information of the user of the device to the translated second information. When the other translation devices receive the translated information, they may also identify which device the translated information comes from and who the corresponding user is. When the information is displayed on the translation device, the user may determine the identity of the speaker. In chaotic scenarios such as multi-person and multi-language, it is also possible to clearly identify the speaker and improve the user experience.

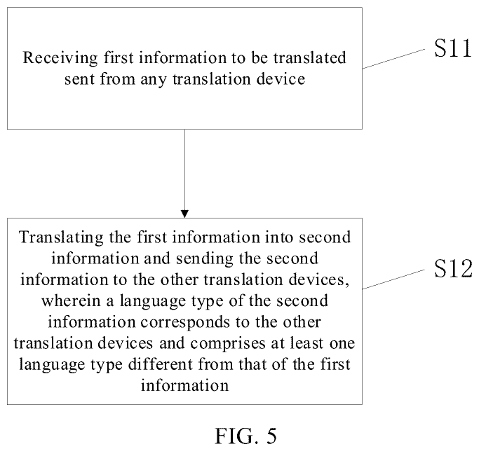

Embodiments of the present disclosure further provide a control method for a docking station for a translation device, which is applied to the docking station of any of the embodiments of the foregoing docking station for the translation device. As shown in FIG. 5, the method comprises:
step S11, receiving first information to be translated sent from any translation device;
step S12, translating the first information into second information and sending the second information to the other translation devices, wherein a language type of the second information corresponds to the other translation devices and comprises at least one language type different from that of the first information.

Optionally, “translating the first information into second information and sending the second information to the other translation devices” comprises: determining a language type corresponding to each of the other translation devices respectively; translating the first information based on the language type corresponding to each of the other translation devices, and sending translated information to corresponding other translation devices based on language types.

An embodiment of the present disclosure further provides a translation system, which includes any docking station for a translation device according to the embodiments of the docking station for the translation device, and a plurality of translation devices.

Optionally, the translation device is provided with a display unit and/or a speaker unit, the display unit is configured for displaying the second information, and the speaker unit is configured for playing the second information.

Each of the various embodiments of the present disclosure has been described in a progressive manner. Identical or similar parts among the embodiments can be referred to each other, and each embodiment focuses only on differences from the other embodiments. In particular, for the apparatus and device embodiments, since they are generally similar to the method embodiments, the descriptions thereof are relatively brief, and related parts can be explained by referring to the corresponding part of the method embodiments.

The foregoing description has been made with respect to specific embodiments of the present disclosure. Other embodiments fall within the scope of the appended claims. In some cases, the operations or steps recited in the claims may be performed in an order different from that described in the embodiments and still achieve the desired results. Furthermore, the processes illustrated in the drawings do not necessarily require the specific order or sequential order shown to achieve the desired results. In certain implementations, multitasking and parallel processing may also be possible or advantageous.

The embodiments of the present disclosure may be a system, a method, and/or a computer program product. The computer program product may include a computer readable storage medium (or media) having computer readable program instructions thereon for causing a processor to carry out aspects of the embodiments of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments of the present disclosure may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments of the present disclosure.

Aspects of the embodiments of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is well-known to a person skilled in the art that the implementations of using hardware, using software or using the combination of software and hardware can be equivalent.

The foregoing descriptions have set forth various embodiments of the present disclosure. These descriptions are illustrative and are not intended to be exhaustive or limited to the specific embodiments disclosed. Numerous modifications and variations will be readily apparent to those skilled in the art without departing from the scope and spirit of the illustrated embodiments. The terminology used herein was chosen with the purpose of best explaining the principles of the embodiments, their practical applications, or technical improvements over existing technologies in the market, or to enable others of ordinary skill in the art to understand the embodiments disclosed herein.

1. A docking station for two or more translation devices, comprising:
a communication module in wireless communication connection with at least a first translation device and a second translation device, the communication module configured for receiving first information to be translated sent from the first translation device and sending translated second information to at least the second translation device based on the wireless communication connection, a language type of the second information corresponding to the second translation device and the second information comprising at least one language type different from that of the first information; and
a control module configured for receiving the first information transmitted by the communication module, translating the first information into the second information, and sending the second information to at least the second translation device via the communication module.

2. The docking station according to claim 1, comprises a charging module, which comprises a plurality of charging ports configured for charging the translation devices.

3. The docking station according to claim 1, further comprises a display module configured for displaying status information of the plurality of translation devices, and the status information at least comprises a language type corresponding to each of the translation devices.

4. The docking station according to claim 3, wherein the docking station is provided with an interaction control comprising a physical control and/or a virtual control displayed on the display module for each of the plurality of translation devices, and the interaction control is at least configured for setting a language type corresponding to each of the translation devices.

5. The docking station according to claim 1, wherein the plurality of translation devices are provided with interaction controls comprising virtual controls and/or physical controls, and the interaction controls are configured for setting language types corresponding to the plurality of translation devices, and sending the language types corresponding to the translation devices to the docking station based on the wireless connection.

6. The docking station according to claim 1, wherein said translating the first information into the second information, and sending the second information to at least the second translation device via the communication module, comprises:
determining a language type corresponding to the second translation device and
translating the first information based on the language type corresponding to the second translation device, and sending translated information to at least the second translation device associated with the language type via the communication module.

7. The docking station according to claim 6, wherein the control module is further configured for adding identity information of a translation device sending the first information to the second information, such that users of the second translation device determine a source of the second information.

8. A control method for a docking station for a translation device, wherein the method is applied to the docking station for the translation device according to claim 1, the method comprises:
receiving first information to be translated sent from the first translation device; and
translating the first information into second information and sending the second information to at least the second translation device, wherein a language type of the second information corresponds to the second translation device and the second information comprises at least one language type different from that of the first information.

9. The method according to claim 8, said translating the first information into second information and sending the second information to at least the second translation device, comprises:
determining a language type corresponding to the second translation device respectively; and
translating the first information based on the language type corresponding to the second translation device, and sending translated information to at least the second translation device associated with the language type.

10. A translation system, comprising a docking station according to claim 1 and a plurality of translation devices, wherein the dock station is configured to integrate with the plurality of translation devices.
